(19) United States
(12) Patent Application Publication
(10) Pub. No.: US 2005/0249288 A1
(43) Pub. Date: Nov. 10, 2005

(54) Adaptive-weighted motion estimation method and frame rate converting apparatus employing the method

(75) Inventor: Tae-hyeun Ha, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/125,095

(22) Filed: May 10, 2005

(30) Foreign Application Priority Data
May 10, 2004 (KR) 10-2004-0032594

(51) Int. Cl. H04N 7/12

(52) U.S. Cl. 375/240.16; 375/240.12

(57) ABSTRACT

An adaptive-weighted motion estimation method and a frame rate converting apparatus employing the method are provided. The method includes estimating a global motion vector by a correlation between frames, and calculating a block matching value between the frames according to a weight value where the estimated global motion vector is applied and determining a lowest block matching value to be a motion vector.

### BACKGROUND OF THE INVENTION

This application claims the priority of Korean Patent Application No. 10-2004-0032594, filed on May 10, 2004, in the Korean Intellectual Property Office, the disclosure of which is incorporated herein in its entirety by reference.

1. Field of the Invention

The present invention relates to a frame rate conversion system, and more particularly, to an adaptive-weighted motion estimation method and a frame rate converting apparatus employing the method.

2. Description of the Related Art

In general, frame rate conversion is carried out to establish compatibility between broadcast standards, such as Phase Alternating Line (PAL) or National Television System Committee (NTSC), in a personal computer (PC) or a high definition television (HDTV). Frame rate conversion is the act of converting one frame to another. In particular, the frame rate up-conversion requires a process of interpolating new frames. Recently, with the development of broadcast technologies, frame rate conversion is carried out after the compression of image data by means of image compression methods, such as Moving Picture Experts Group (MPEG) and H.263.

Image signals in such an image processing system involve much redundancy caused by high correlations between the image signals. The image signals can be effectively compressed by eliminating the redundancy. In order to effectively compress time-varying video frames, the redundancy in the direction of the time-axis needs to be eliminated. In other words, an amount of data to be transferred can be greatly reduced by replacing frames unchanged or slightly changed with immediately preceding frames. Motion estimation (ME) is a task of identifying the most similar blocks between a preceding frame and a current frame. A motion vector (MV) indicates an amount of displacement of a block in the ME.

In general, ME takes advantage of block-based motion estimation (BME) in consideration of a possibility of real-time processing, a hardware implementation, etc.

The BME divides consecutively input images into pixel blocks having uniform dimensions, and searches for the most similar blocks between a preceding or following frame and a current frame with respect to each of the divided pixel blocks and determines an MV. Mean absolute difference (MAD), mean square error (MSE), or sum of absolute difference (SAD) is mainly used in order to determine an amount of similarity between adjacent blocks in the BME. The MAD has a small number of operations because a multiplying operation is not required, whereby a hardware implementation is simple. The BME using the MAD estimates a block having the minimum MAD value among blocks within a frame adjacent to a block within a reference frame, and obtains an MV between the two blocks.

In general, an MV having the minimum MAD value indicates an amount of an actual displacement of an object between two frames. In a complicated image, however, an MV estimated through the MAD and an MV indicating a motion of an actual object are commonly different from each other.

FIG. 1 is a diagram showing occurrence of a block artifact in an MCI frame due to the failure of ME.

FIGS. 1A and 1B show preceding and current frames among adjacent image sequences, respectively. An ‘H’-shaped image is moving from left to right along the horizontal axis. It is assumed that when the BME is carried out between frames, the ME fails in a block located in a top-right portion of FIG. 1A, while an MV estimated by the MAD operation and an MV indicating a motion of an actual object are equal in most blocks of the ‘H’-shaped image. FIGS. 1C and 1D show frames to be interpolated between the frame of FIG. 1B and the frame of FIG. 1A by using “true motion” and “MAD_{MIN}”, respectively. At this time, two frames shown in FIGS. 1C and 1D are almost the same and a block artifact does not occur. FIGS. 1E and 1F show frames where motion compensated interpolation (MCI) is applied between frames of FIGS. 1A and 1B by using “true motion” and “MAD_{MIN}”, respectively. As shown in FIG. 1E, the block artifact does not occur when the MCI is performed by using the MV indicating a motion of an actual object. However, as shown in FIG. 1F, the block artifact occurs when the MCI is performed by using the MV having the minimum MAD value. In FIG. 1F, a portion where the block artifact occurs is circled.

As a result, if the ME of an actual object fails when the MCI is performed in the frame rate conversion, block artifacts are generated in the interpolated image.

In addition, most of the MVs collect in the vicinity of (0,0) in image sequences. In other words, two adjacent image frames are unchanged or only slightly changed in motion in a greater part of the frame area. It is probable that an image of a frame remains unchanged in motion. Thus, in a conventional vector estimation method, an MV closer to (0,0) is more weighted among two different candidate MVs having similar MAD values. However, in case of an image sequence with global motion resulting from panning or zooming of a camera, most of the MVs are located around a global MV rather than around (0,0). Therefore, there is a problem in that usage of the conventional vector estimation method may cause serious deterioration of an image.

### SUMMARY OF THE INVENTION

The present invention provides an ME method that has improved ME efficiency between image frames having global motion by performing ME and motion compensated interpolation by using an adaptive-weighted MAD.

The present invention further provides a method and apparatus for converting a frame rate, which employs the adaptive-weighted ME method.

According to an aspect of the present invention, there is provided an ME method comprising: storing an input image frame by frame; estimating a global MV by a correlation between the stored frames; and calculating a block matching value between the frames according to a weight value where the estimated global MV is applied, and determining a minimum block matching value to be an MV.

According to another aspect of the present invention, there is provided a method of converting a frame rate, comprising: storing an input image frame by frame; estimating a global MV by a correlation between the stored frames; calculating a block matching value between the frames according to a weight value where the estimated global MV is applied, and determining a minimum block matching value to be an MV; eliminating an outlier by filtering the determined MV; and generating a pixel value to be interpolated between frames using the filtered MV and pixel values of matching blocks between adjacent frames.

According to another aspect of the present invention, there is provided a frame rate converting apparatus comprising: a frame buffer unit storing an input image frame by frame; a global ME unit estimating a global MV by a correlation between frames stored in the frame buffer means; a block ME unit calculating a block matching value between the frames according to a weight value where the global MV estimated in the global ME means is applied, and determining a minimum block matching value to be an MV; and a motion compensated interpolation unit generating a pixel value to be interpolated between frames using the MV estimated in the block ME means and pixel values of matching blocks between the frames.

### BRIEF DESCRIPTION OF THE DRAWINGS

The above and other features and advantages of the present invention will become more apparent by describing in detail exemplary embodiments thereof with reference to the attached drawings in which:

FIGS. 1A to 1F are diagrams showing the occurrence of a block artifact in an MCI frame due to the failure of an ME;

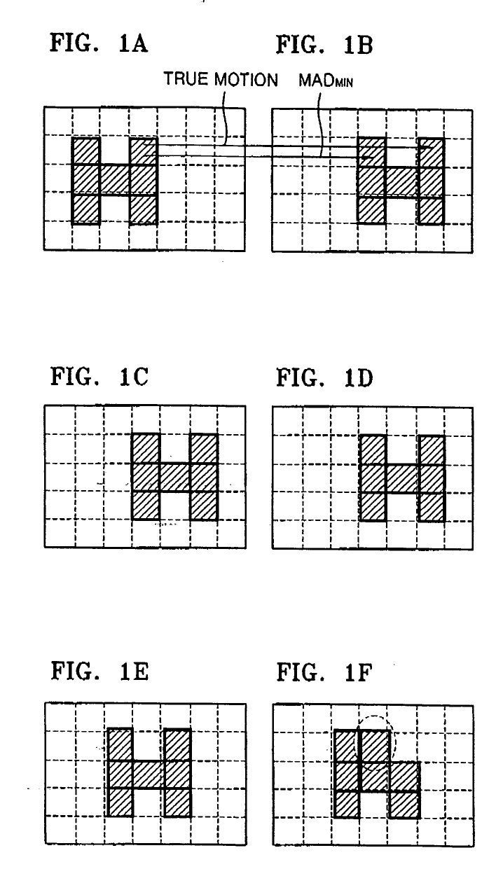

FIG. 2 is a flowchart showing an adaptive-weighted ME method according to the present invention; and

FIG. 3 is a block diagram showing a frame rate converting apparatus employing an ME method according to the present invention.

### DESCRIPTION OF EXEMPLARY EMBODIMENTS

Exemplary embodiments according to the present invention will now be described in detail with reference to the accompanying drawings.

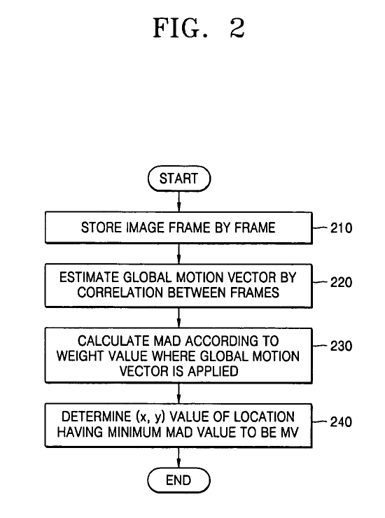

FIG. 2 is a flowchart showing an adaptive-weighted ME method according to the present invention.

First, an input image is stored frame by frame (Operation 210).

Next, a global MV (gₓ, g_{y}) is estimated by using a correlation between an (n-1)-th frame Fₙ₋₁ and an n-th frame Fₙ (Operation 220). The global MV (gₓ, g_{y}) is expressed by Equation 1.

$$\begin{matrix}{g}_{x} = arg {min}_{x ∈ {S}_{h}} \{ {\sum }_{h = 0}^{{N}_{h}} {H}_{n - 1} ( h ) {H}_{n} ( h + x ) \} , \\ {g}_{y} = arg {min}_{y ∈ {S}_{v}} \{ {\sum }_{v = 0}^{{N}_{v}} {V}_{n - 1} ( v ) {V}_{n} ( v + y ) \}\end{matrix} \qquad [ Equation 1 ]$$

where H₋₁ and Hₙ denote mean values for all pixels within an h-th column in the (n−1)-th frame Fₙ₋₁ and the n-th frame Fₙ. Vₙ₋₁ and Vₙ denote mean values for all pixels within a v-th row in the (n-1)-th frame Fₙ₋₁ and the n-th frame Fₙ. Nₕ and Nᵥ denote horizontal and vertical correlation coefficients. Sₕ and Sᵥ denote search scopes for horizontal and vertical global motions.

Next, an adaptive-weighted mean absolute difference (MAD) value is calculated (Operation 230). The adaptive-weighted MAD (AWMAD) is expressed by Equation 2.
AWMAD(x,y)=MAD(k,l) (x,y)(1+KD) [Equation 2]
where K denotes an elasticity coefficient and is obtained with an experimental value, and D denotes a weight value where the global MV (gₓ, g_{y}) is applied.

The MAD is calculated from Equation 3.

$${MAD}_{( k , l )} ( x , y ) = {\sum }_{i = 1}^{{N}_{1}} {\sum }_{j = 1}^{{N}_{2}} \frac{\vert \begin{matrix}{f}_{n - 1} ( k + i + x , l + j + y ) - \\ {f}_{n} ( k + i , l + j )\end{matrix} \vert}{{N}_{1} \times {N}_{2}} \qquad [ Equation 3 ]$$

where n denotes a variable indicating a sequence of input frames in a time domain, (i, j) denotes a variable indicating spatial coordinates of pixels, and (x, y) denotes a variable indicating a distance difference between two matching blocks. (k, 1) denotes a variable indicating spatial coordinates of two blocks consisting of N₁×N₂ pixels, where N₁ and N₂ denote horizontal and vertical sizes of two matching blocks, respectively.

In addition, the weight value D is expressed by Equation 4.

$$D = ( {[ \frac{x - {g}_{x}}{{Q}_{x}} ]}^{2} + {[ \frac{y - {g}_{y}}{{Q}_{y}} ]}^{2} ) \qquad [ Equation 4 ]$$

where [x/Q] denotes the highest integer not greater than x/Q, and Qₓ and Q_{y} denote quantized constants. In order to avoid such an error that an actual MV converges into the global MV (gₓ, g_{y}) by a weight value despite not being the global MV (gₓ, g_{y}) in an image having gentle MAD characteristics, a difference between the global MV and an MV corresponding to a currently estimated location is quantized with units of Qₓ and Q_{y}.

Returning to Equation 3, the closer to the global MV (gₓ, g_{y}) the MAD is, the lower the weight value D is. Therefore, in case of two different candidate MVs having the same or similar MAD values, a candidate MV closest to the global motion has a comparative advantage.

Next, an (x, y) value of a location having a minimum adaptive-weighted MAD value is determined to be an MV (Operation 240). A last MV is obtained from Equation 5.

$${( {x}_{m} , {y}_{m} )}_{( k , l )} = arg {min}_{( x , y ) ∈ S} \{ {AWMAD}_{( k , l )} ( x , y ) \} \qquad [ Equation 5 ]$$

where S denotes a search range for ME, and (xₘ, yₘ) denotes an MV for a block having the minimum MAD value.

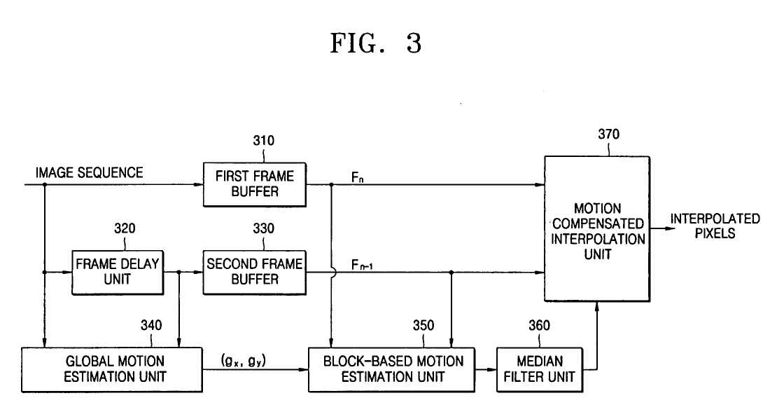

FIG. 3 is a block diagram showing a frame rate converting apparatus employing an ME method according to the present invention.

A first frame buffer 310 stores an input image sequence frame by frame. A frame delay unit 320 delays the input image sequence on a frame by frame basis. A second frame buffer 330 stores frame by frame the image signal delayed a frame in the frame delay unit 320.

The global ME unit 340 estimates a global MV (gₓ, g_{y}) on the basis of an n-th frame Fₙ output from the first frame buffer 310 and an (n-1)-th frame Fₙ₋₁ output from the second frame buffer 330.

A block-based ME unit 350 determinates a weight value where the global MV (gₓ, g_{y}) estimated in the global ME unit 340 is applied, calculates an MAD value between the n-th frame Fₙ and the (n-1)-th frame Fₙ₋₁ according to the weight value, and identifies a minimum MAD value among the MAD values to be an MV. At this time, the sum of absolute difference (SAD) or mean absolute error (MAE) can be used instead of the MAD.

A median filter unit 360 eliminates an outlier from the MV estimated in the block-based ME unit 350, and adjusts the MV smoothly.

A motion compensated interpolation unit 370 generates a pixel value to be interpolated between frames by applying the MV filtered in the median filter unit 360 to N₁×N₂ pixels of the n-th frame and the (n-1)-th frame stored in the first frame buffer 310 and the second frame buffer 330, respectively. For instance, assuming that pixel values within blocks B belonging to a frame Fₙ, a frame Fₙ₋₁, and a frame Fᵢ are fₙ, fₙ₋₁, and fᵢ, respectively, and a coordinate value belonging to the frame Fₙ is x, an image signal to be interpolated with motion compensation is expressed by Equation 6 below.
fᵢ(x+MV(x)/2)={fₙ(x)+fₙ₋₁(x+MV(x))}/2 [Equation 6]

While the present invention has been described with reference to exemplary embodiments thereof, it will be understood by those skilled in the art that various changes in form and details may be made therein without departing from the scope of the present invention as defined by the following claims.

In addition, it is possible to implement with a computer-readable code on a computer-readable recording medium. Examples of the computer-readable recording medium include all kinds of recording devices in which data to be read by a computer system is stored, such as ROM, RAM, CD-ROM, magnetic tape, hard disk, floppy disk, flash memory, and optical storage device. A medium implemented in a form of a carrier wave (e.g., transmission via Internet) is another example of the computer-readable recording medium. Further, the computer-readable recording medium can be distributed in a computer system connected through a network, and be recorded and implemented with a computer-readable code in a distributed manner.

According to the present invention, it is possible to improve ME efficiency between image frames with global motion corresponding to a motion of the entire screen by performing ME and motion compensated interpolation by using an adaptive-weighted MAD.

1. A motion estimation method comprising:
storing an input image frame by frame;
estimating a global motion vector by a correlation between the stored frames; and
calculating a block matching value between the frames according to a weight value where the estimated global motion vector is applied, and determining a minimum block matching value to be a motion vector.

2. The motion estimation method of claim 1, wherein the closer to a global motion vector the block matching value is, the lower a weight value is.

3. The motion estimation method of claim 1, wherein, in case of two different candidate motion vectors having the same block matching value, a candidate motion vector closest to the global motion has a comparative advantage.

4. The motion estimation method of claim 1, wherein the weight value D is expressed as follows:
$$D = ( {[ \frac{x - {g}_{x}}{{Q}_{x}} ]}^{2} + {[ \frac{y - {g}_{y}}{{Q}_{y}} ]}^{2} ) ,$$
wherein [x/Q] denotes the highest integer not greater than x/Q, gₓ and g_{y} denote global motion vector values, and Qₓ and Q_{y} denote quantized constants.

5. The motion estimation method according to claim 1, wherein the block matching value is MAD (Mean Absolute Difference).

6. A method of converting a frame rate, comprising:
storing an input image frame by frame;
estimating a global motion vector by a correlation between the stored frames;
calculating a block matching value between the frames according to a weight value where the estimated global motion vector is applied, and determining a minimum block matching value to be a motion vector;
eliminating an outlier by filtering the determined motion vector; and
generating a pixel value to be interpolated between frames using the filtered motion vector and pixel values of matching blocks between adjacent frames.

7. A frame rate converting apparatus comprising:
a frame buffer unit storing an input image frame by frame;
a global motion estimation unit estimating a global motion vector by a correlation between frames stored in the frame buffer unit;
a block motion estimation unit calculating a block matching value between the frames according to a weight value where the global motion vector estimated in the global motion estimation unit is applied, and determining a minimum block matching value to be a motion vector; and
a motion compensated interpolation unit generating a pixel value to be interpolated between frames using the motion vector estimated in the block motion estimation unit and pixel values of matching blocks between the frames.

8. The frame rate converting apparatus of claim 7, further comprising a filter unit filtering an outlier of the motion vector estimated in the block motion estimation unit.

9. The frame rate converting apparatus of claim 8, wherein the filter unit is a median filter.
